(19) United States
(12) Patent Application Publication
(10) Pub. No.: US 2025/0074837 A1
(43) Pub. Date: Mar. 6, 2025

(54) STRUCTURAL MEMBER AND METHOD FOR PRODUCING THE SAME

(71) Applicant: TOTO LTD., Fukuoka (JP)

(72) Inventors: Tatsuya KOGA, Fukuoka (JP); Nobutomo OTSUKA, Fukuoka (JP)

(73) Assignee: TOTO LTD., Fukuoka (JP)

(21) Appl. No.: 18/818,222

(22) Filed: Aug. 28, 2024

(30) Foreign Application Priority Data
Aug. 29, 2023 (JP) 2023-138936

(51) Int. Cl. C04B 41/45; C04B 35/10; C04B 41/00; C04B 41/50; C04B 41/87

(52) U.S. Cl. CPC C04B 41/4529; C04B 35/10; C04B 41/0072; C04B 41/5045; C04B 41/87

(57) ABSTRACT

A structural member 10 includes a base material 100 and a protective film 200 covering a surface 101 of the base material 100. The protective film 200 has been subjected to reduction processing of reducing an in-plane variation in residual stress on a surface 201 of the protective film 200.

### CROSS-REFERENCE TO RELATED APPLICATION

This application is based upon and claims the benefit of priority from Japanese Patent Application No. 2023-138936 filed on Aug. 29, 2023, the entire contents of which are incorporated herein by reference.

### BACKGROUND

### Field of the Invention

The present invention relates to a structural member and a method for producing the same.

### Description of the Related Art

Structural members having a protective film on a surface of a base material are used in various fields such as semiconductor manufacturing apparatus. For example, as described in Japanese Patent Laid-Open No. 2007-321183, in a semiconductor manufacturing apparatus, a protective film is formed on a surface of a base material constituting an inner wall of a chamber in order to protect the base material from plasma. As such a protective film, for example, an oxide ceramic such as yttria is used.

### SUMMARY

Since the protective film is a film for protecting the base material from plasma as described above, it must naturally have sufficient durability against plasma. However, the durability may be locally decreased in a portion of the protective film, so that the deteriorated protective film may arise a source of particle. The present inventors have found as a result of diligent research on its cause that in a case in which the residual stress generated by polishing upon manufacturing or the like is locally large on a surface of a protective film, the durability of the portion (specifically, resistance to halogens such as fluorine and chlorine) was decreased.

The present invention was made in view of these problems, and an object of the present invention is to provide a structural member capable of ensuring sufficient durability against plasma, and a method for producing the same.

In order to solve the above problem, the structural member according to the present invention includes a base material and a protective film covering a surface of the base material. The protective film has been subjected to reduction processing of reducing an in-plane variation in residual stress on a surface of the protective film.

Such a structural member has been subjected to reduction processing on a surface of a protective film. The “reduction processing” is a reduction to reduce an in-plane variation in residual stress on a surface. Such reduction processing can include, for example, processing of releasing a local residual stress by heating to smooth it, processing of removing a portion of the protective film by etching, and the like. The reduction processing allows a distribution of residual stress on a surface of a protective film to be generally uniform. As a result, the sufficient durability against plasma can be ensured on the entire protective film.

A method for producing the structural member described above includes a step of providing a base material, a step of forming a protective film on a surface of the base material, and a step of subjecting the protective film to reduction processing which is processing of reducing an in-plane variation in residual stress on a surface of the protective film.

According to the present invention, a structural member capable of ensuring sufficient durability against plasma, and a method for producing the same can be provided.

### BRIEF DESCRIPTION OF THE DRAWINGS

FIG. 1 shows a schematical diagram of a cross-section of the structural member according to the present embodiment;

FIG. 2 shows an image obtained by observing a surface of the structural member according to the present embodiment using an electron microscope;

FIG. 3 shows a diagram for explaining a distribution of residual stress on a surface of a protective film; and

FIGS. 4A to 4D show a diagram for explaining the method for producing a structural member according to the present embodiment.

### DETAILED DESCRIPTION

The present embodiment will be described by referring to the attached drawings. In order to facilitate understanding of the description, an identical constituent is indicated with the same sign as far as possible in each drawing, and duplicated explanations will be omitted.

A structural member 10 according to the present embodiment is used as a member constituting an inner wall of a processing chamber in a semiconductor manufacturing apparatus (not shown), for example, such as a plasma etching apparatus. Note, however, the application of such structural member 10 is only an example, and should not be limited for the semiconductor manufacturing apparatus.

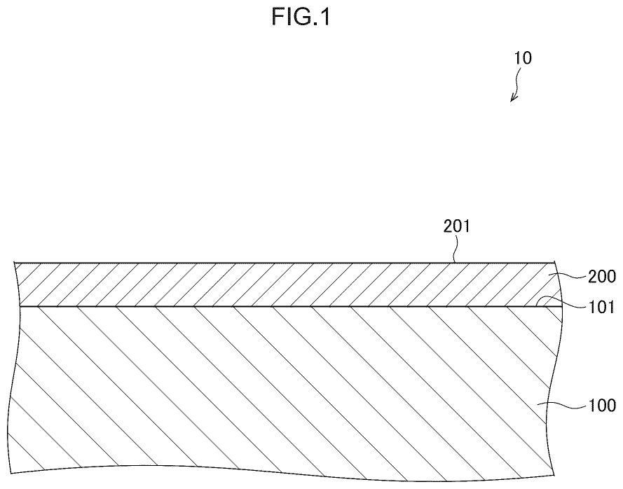

As shown in FIG. 1, the structural member 10 includes a base material 100 and a protective film 200. In a plasma etching apparatus and the like, a surface 201 of the protective film 200 is exposed toward a space in the chamber. The protective film 200 is arranged for the purpose of protecting a surface 101 of the base material 100 from plasma.

The base material 100 is a member that mostly occupies the entire structural member 10. In the present embodiment, the base material 100 is composed of a sintered ceramic body containing high-purity aluminum oxide (Al2O3), but may be made of a different type of ceramic. The surface 101 of the base material 100 is a flat surface in the present embodiment, but the surface 101 may have a convex and concave structure, a slope, or the like.

As described above, the protective film 200 is a film formed to protect the base material 100 against plasma. The protective film 200 is formed so as to cover the entire surface 101 of the base material 100. The protective film 200 is a film containing polycrystalline yttria (Y2O3), and is formed using an aerosol deposition method in the present embodiment. A thickness of the protective film 200 is appropriately set depending on a length of period of time required to maintain durability or the like. In the present embodiment, the thickness of the protective film 200 is 10 μm. A material and formation method of the protective film 200 may be different from those described above.

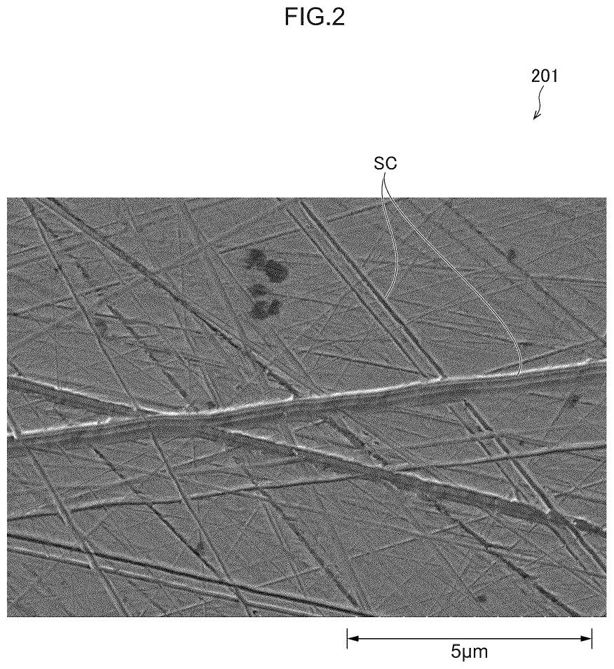

As will be describe below, after the protective film 200 has been formed on the base material 100, a surface 201 is mechanically polished for the purpose of adjusting the surface 201 for its surface roughness and the like. FIG. 2 shows an image obtained by observing the surface 201 immediately after polishing with an electron microscope. As shown in the figure, a large number of scratches SC are formed on the surface 201 after polishing. Each scratch SC is a trace where the surface 201 of the protective film 200 has been scratched by fine diamond abrasive grains.

By the way, when a conventional structural member is exposed to plasma in a processing chamber, a portion of a protective film deteriorates significantly compared to the circumference thereof, as a result of which the deteriorated portion has arisen as a source of particles. The present inventors have found as a result of diligent research on its cause of such a local decrease in durability in the portion of the protective film that durability against plasma was significantly decreased in a portion with a scratch SC of the surface of the protective film, as shown in FIG. 2. Further research has found that the cause of the local decrease in durability of the protective film against plasma was a local increase in residual stress in the protective film.

The aforementioned “residual stress” is generated, for example, when the surface 201 is polished, and remains in the protective film 200 along each scratch SC, as shown in FIG. 2. The present inventors have confirmed that when the surface 201 after polishing was directly exposed to fluorine-based plasma without the reduction processing described below, the portion with the scratch SC (i.e., the portion with a large residual stress) is fluorinated more deeply than the circumference thereof. The present inventors have also confirmed, using techniques such as Raman scattering spectroscopy, that the residual stress in the portion with the scratch SC is larger immediately after polishing than the residual stress at the circumference thereof. From the above, the local residual stress is considered to lower the chemical resistance of the protective film 200 in the corresponding portion.

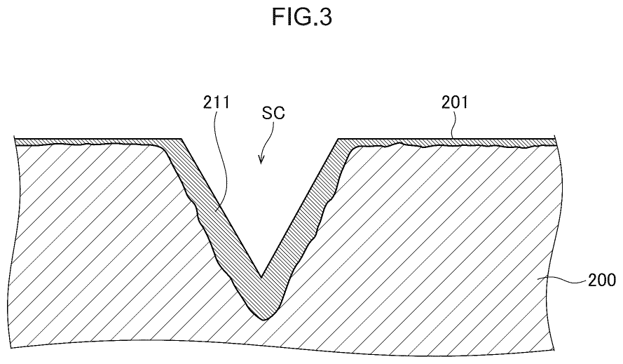

FIG. 3 shows a schematical diagram of a cross-section of the protective film 200 immediately after polishing. Of the cross-section, a portion with different hatching and denoted as a sign 211 is a portion where the stress generated upon polishing remains. The residual stress at the portion with the scratch SC is larger and remains deeper than the residual stress at the circumference thereof. Therefore, the inner surface of the scratch SC has lower durability against plasma than the circumference thereof.

When the surface 201 of the protective film 200 is exposed to plasma in such a condition, there is a possibility that mainly the inner surface of the scratch SC deteriorates due to the plasma, so that the deteriorated protective film 200 would arise as a source of particles. The reason for the deteriorated portion arising as a source of particles is considered because the protective film 200 expands in volume accompanying fluorination and the like, and a large number of microcracks are generated on the surface 201.

Therefore, in the structural member 10 according to the present embodiment, the surface 201 after polishing has been subjected to reduction processing. “Reduction processing” refers to processing of reducing an in-plane variation in residual stress on the surface 201. Various manners of processing can be adopted as the reduction processing, however, in the present embodiment, processing such that the entire structural member 10 including the protective film 200 is heated to a predetermined temperature or higher, is performed as the reduction processing described above.

When the protective film 200 is a film containing yttria (Y2O3) as in the present embodiment, the protective film 200 is preferably heated to a temperature of 800° C. or higher. Such processing releases a local residual stress particularly at the scratch SC, and reduces an in-plane variation in residual stress in the protective film 200. A generally uniform distribution of residual stress on the surface 201 of the protective film 200 results, making it possible to ensure sufficient durability against plasma on the entire protective film 200.

The reduction processing may be processing of releasing and smoothing a local residual stress by heating or the like, however, as described above, it may also be processing of removing a portion with a larger residual stress of the protective film 200 (specifically, a surface layer portion). In this case, for example, processing of chemically etching the surface 201 of the protective film 200 is preferably employed so that no new residual stress is generated due to the removal. In a case in which the protective film 200 is a film containing yttria (Y2O3) as in the present embodiment, a surface layer portion of the protective film 200 can be removed using, for example, hydrochloric acid. Instead of chemical etching, the surface layer portion of the protective film 200 may be physically removed using a method such as shot peening.

The in-plane variation in residual stress in the protective film 200 may result due to causes other than the polishing for the surface 201 as described above. Even in such a case, the surface 201 preferably undergoes reduction processing to reduce an in-plane variation in residual stress. That is, the target of the reduction processing may be the surface 201 that is not polished.

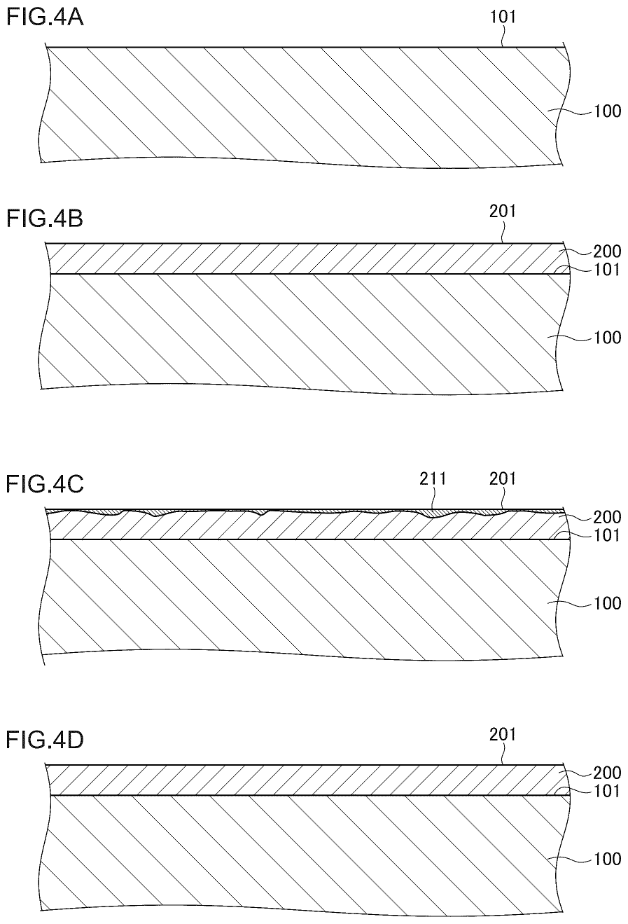

A method for producing the structural member 10 will be described with reference to FIGS. 4A to 4D. First, as shown in FIG. 4A, the base material 100 is provided. It is preferable that the surface 101 of the base material 100 has been preliminarily adjusted for surface roughness thereof, and the like to the extent that the protective film 200 can be stably formed thereafter.

Subsequently, as shown in FIG. 4B, the protective film 200 is formed so as to cover the surface 101 of the base material 100. As described above, in the present embodiment, the protective film 200 is formed using an aerosol deposition method, but the protective film 200 may be formed using other methods. For example, the protective film 200 may be formed by PVD or CVD.

Subsequently, the surface 201 of the protective film 200 is subjected to mechanical polishing. This allows the surface 201 to be adjusted for the surface roughness and the like. FIG. 4C schematically shows a state of the surface 201 after polishing. A large number of scratches SC (not shown in FIG. 4C) as shown in FIG. 2 are formed on the surface 201. A residual stress is generated on the surface 201 accompanying the polishing. In FIG. 4C, the portion where stress remains is denoted with the sign “211” as in FIG. 3. As explained above, the residual stress at the portion with the scratch SC is larger and remains deeper than the residual stress at the circumference thereof.

After completion of polishing, the surface 201 is subjected to the reduction processing. This releases the residual stress on the surface 201. When the surface 201 was subjected to reduction processing, as shown in FIG. 4D, the portion (the portion with the sign 211) where a residual stress is locally large on the surface 201, is mostly no longer present. In other words, the in-plane variation in residual stress is reduced. This ensures sufficient durability of the protective film against plasma.

So far, the present embodiments have been described with reference to specific examples. However, the present disclosure is not limited to these specific examples. Design changes appropriately made to these specific examples by those skilled in the art are also included in the scope of the present disclosure as long as they include the features of the present disclosure. Each element included in each of the aforementioned specific examples, as well as their arrangement, conditions, shapes, and the like, are not limited to those exemplified, and can be appropriately changed. Each element included in each of the aforementioned specific examples can be appropriately combined as long as no technical inconsistency thereof results.

What is claimed is:

1. A structural member comprising a base material and a protective film covering a surface of the base material,
wherein the protective film has been subjected to reduction processing of reducing an in-plane variation in residual stress on a surface of the protective film.

2. The structural member according to claim 1, wherein a surface of the protective film is a surface subjected to polishing prior to the reduction processing.

3. The structural member according to claim 1, wherein the protective film is a film formed by an aerosol deposition method.

4. A method for producing a structural member, comprising
a step of providing a base material,
a step of forming a protective film on a surface of the base material, and
a step of subjecting the protective film to reduction processing which is processing of reducing an in-plane variation in residual stress on a surface of the protective film.

5. The method for producing a structural member according to claim 4, wherein the reduction processing is processing of heating the protective film to a predetermined temperature or higher.

6. The method for producing a structural member according to claim 4, wherein the reduction processing is processing of chemically etching a surface of the protective film.
